(19) United States
(12) Patent Application Publication
(10) Pub. No.: US 2026/0080254 A1
(43) Pub. Date: Mar. 19, 2026

(54) DEVICE AND METHOD FOR CONSTRUCTING DATASET FOR MULTIPLE TASKS THROUGH SELECTIVE LABELING USING ACTIVE LEARNING AND ACTIVE FORGETTING

(71) Applicant: CHUNG ANG UNIVERSITY INDUSTRY ACADEMIC COOPERATION FOUNDATION, Seoul (KR)

(72) Inventors: EUN WOO KIM, Seoul (KR); JI HO LEE, Seoul (KR)

(21) Appl. No.: 19/332,256

(22) Filed: Sep. 18, 2025

(30) Foreign Application Priority Data
Sep. 19, 2024 (KR) 10-2024-0126759

(51) Int. Cl. G06N 3/091

(52) U.S. Cl. CPC G06N 3/091

(57) ABSTRACT

A device for constructing a dataset for multiple tasks through selective labeling using active learning and active forgetting includes a data collector configured to collect data for multi-task learning and a classifier that includes a deep learning model for performing the multi-task and is configured to classify useful data useful for performing a specific task through active learning using the deep learning model among the collected data, and unuseful data not useful for performing the specific task through active forgetting using the deep learning model among the identified useful data.

### CROSS-REFERENCE TO RELATED APPLICATION AND CLAIM OF PRIORITY

This application claims the benefit under 35 USC § 119(a) of Korean Patent Application No. 10-2024-0126759 filed on Sep. 19, 2024 in the Korean Intellectual Property Office, the entire disclosure of which is incorporated herein by reference for all purposes.

### BACKGROUND

### 1. Field

The present disclosure relates to a device and method for constructing a dataset for multiple tasks through selective labeling using active learning and active forgetting.

### 2. Description of Related Art

With the advent of the artificial intelligence era, computers have begun to perform human-like tasks, such as perception and judgment. The amount of data required for such tasks is unlimited, and the types of data available are diverse, including video, images, audio, text, and binary data. In the fields of machine learning and artificial intelligence, the more data input, the more accurate the recognition and prediction of information generally becomes.

Since unprocessed data in the fields of machine learning and artificial intelligence is abstract and broad in nature, it is necessary to process, classify, and designate the data into a usable form. This requirement also applies to image data labeling. Training cannot be considered to be completed solely through data labeling by artificial intelligence or computer programs, and human check and verification are essential for data labeling.

Deep learning generally requires a large amount of training data, but constructing training data requires significant costs for data labeling. Furthermore, in multi-task learning, pixel-level labeling or sophisticated labeling is required, which substantially increases costs. As a result, data constructed for multi-task learning often contains missing labels or labels that are inaccurately assigned.

In conventional data labeling techniques, labeled data is continuously accumulated and expanded to construct a dataset without evaluating the usefulness of the generated labels, such as whether they are missing or incorrect. Therefore, this leads to inefficient budget allocation as unuseful data is allocated and accumulated within a limited budget. This may not help improve model performance because model training may be performed with labels that are not actually useful.

In addition, for multi-task learning that performs multiple tasks with one input, existing conventional techniques select one useful task among several tasks to label the task or label all tasks.

However, due to the nature of learning that performs multiple tasks with a single input, the input may be useful for certain tasks but not for others. Therefore, identifying useful tasks and labeling them is crucial, and thus research has been focused on techniques to reduce data labeling costs by progressively selecting and labeling important data samples. Constructing a dataset is a crucial step in learning, but in multi-task learning, it becomes increasingly complex and expensive, often leading to inaccurately labeled data and degraded performance, which is problematic. In this context, since certain samples may provide limited utility for specific tasks, it is advantageous to discard previously obtained less useful data and to prioritize newly acquired informative data for efficient dataset construction.

Examples of related art may include Korean Unexamined Patent Application Publication Nos. 10-2024-0025935 and 10-2024-0107019.

### SUMMARY

Embodiments of the present disclosure are intended to provide a device and method for constructing a dataset for multiple tasks through selective labeling using active learning and active forgetting.

According to an embodiment of the present disclosure, there is provided a device that includes one or more processors and a memory storing one or more programs executed by the one or more processors, the device including a data collector configured to collect data for multi-task learning and a classifier that includes a deep learning model for performing the multi-task, and is configured to identify and classify useful data useful for performing a specific task through active learning using the deep learning model among the collected data, and unuseful data not useful for performing the specific task through active forgetting using the deep learning model among the identified useful data.

The data collector may be configured to divide the collected data into a labeled dataset and an unlabeled dataset and store the labeled dataset in a labeled data pool and the unlabeled dataset in an unlabeled data pool.

The classifier may be configured to identify useful data from the unlabeled data pool through the active learning and add useful data to the labeled data pool and identify unuseful data from the labeled data pool through the active forgetting and move the unuseful data to the unlabeled data pool.

The classifier may be configured to calculate a non-usefulness score for each data to select data that is not useful for performing the task.

The non-usefulness score may be calculated for each data by a difference between a loss when the deep learning model is trained using the data and a loss when the deep learning model is subjected to unlearning on the data.

According to another embodiment of the present disclosure, there is provided a method performed on a computing device that includes one or more processors and a memory storing one or more programs executed by the one or more processors, the method including collecting data for multi-task learning and classifying useful data useful for performing a specific task through active learning using the deep learning model among the collected data, and unuseful data not useful for performing the specific task through active forgetting using the deep learning model among the identified useful data.

The collecting of the data may include dividing the collected data into a labeled dataset and an unlabeled dataset and storing the labeled dataset in a labeled data pool and the unlabeled dataset in an unlabeled data pool.

In the classifying, useful data may be identified from the unlabeled data pool through the active learning and adding useful data to the labeled data pool and unuseful data may be identified from the labeled data pool through the active forgetting and moving the unuseful data to the unlabeled data pool.

The classifying may include calculating a non-usefulness score for each data to select data that is not useful for performing the task.

### BRIEF DESCRIPTION OF THE DRAWINGS

FIG. 1 is a diagram illustrating the configuration of a device for constructing a dataset for multiple tasks through selective labeling using active learning and active forgetting according to an embodiment of the present disclosure.

FIG. 2 is a diagram illustrating a process of acquiring and removing data over a total time period by a labeling system according to an embodiment of the present disclosure.

FIG. 3 is a flowchart illustrating a method of constructing a dataset for multiple tasks through selective labeling using active learning and active forgetting according to an embodiment of the present disclosure.

FIG. 4 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the present invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In the present disclosure, a selective labeling framework (labeling system) through active learning and active forgetting for multi-task learning is proposed. Specifically, it is possible to identify useful data for multi-task learning through active learning to construct an optimal dataset, and to identify and remove unuseful data in units of tasks through active forgetting.

That is, useful data for multi-task learning is identified through active learning to construct an optimal dataset while reducing labeling costs and previously acquired unuseful data is removed and more valuable data is obtained through active forgetting, thereby capable of optimizing data budget allocation and improving model performance.

Active learning and active forgetting may be performed by repeatedly acquiring and learning useful data and removing and performing unlearning on unuseful data until the data budget is exhausted or the model reaches the desired performance.

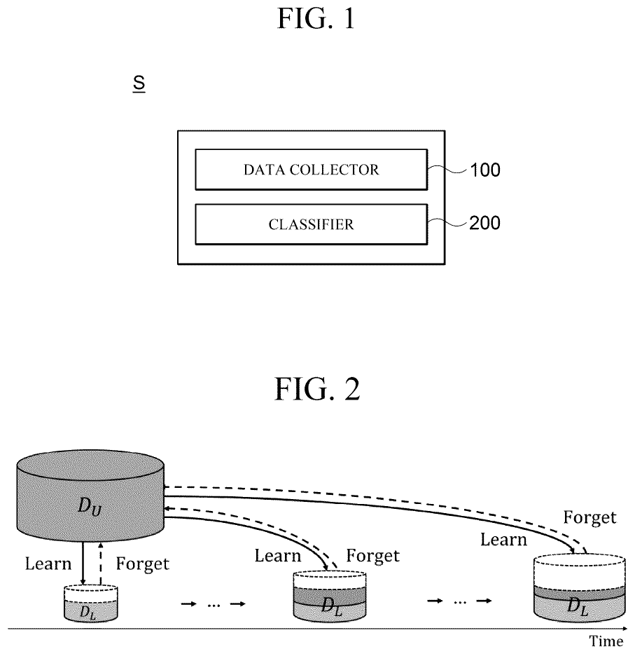

FIG. 1 is a diagram illustrating the configuration of a device for constructing a dataset for multiple tasks through selective labeling using active learning and active forgetting according to an embodiment of the present disclosure.

Referring to FIG. 1, a device S that constructs a dataset may include a data collector 100 and a classifier 200.

The data collector 100 may collect data for multi-task learning. In the field of multi-task learning, it is possible to complete missing labels or supplement the knowledge of the task about missing labels by utilizing the knowledge of accurately labeled tasks. For reference, labeling refers to assigning a correct value to each data sample.

The data collector 100 may divide collected data into a labeled dataset and an unlabeled dataset. The data collector 100 may store the labeled dataset in a labeled data pool and store the unlabeled dataset in an unlabeled data pool.

The classifier 200 may include a deep learning model for performing multiple tasks. The classifier 200 may perform active learning on the deep learning model to identify data useful for performing a specific task, and perform active forgetting on the deep learning model by identifying data that is not useful for performing the specific task.

Here, active learning may include a process of training the deep learning model by identifying useful data from collected data and using the identified useful data as training data. Active forgetting may include a process of performing unlearning, which involves identifying unuseful data from the identified useful data and removing the knowledge of the unuseful data from the deep learning model.

The classifier 200 may identify useful data from the unlabeled data pool and add the useful data to the labeled data pool through active learning. That is, the classifier 200 may label the identified useful data and add the identified useful data to the labeled data pool. Furthermore, the classifier 200 may identify unuseful data from the labeled data pool through active forgetting and move (discard) the unuseful data to the unlabeled data pool.

The classifier 200 may calculate a non-usefulness score for each data to select data that is not useful for performing a task. The non-usefulness score may be calculated for each data by a difference between the loss when a deep learning model is trained using the data and the loss when unlearning is performed on the deep learning model using the data.

FIG. 2 is a diagram illustrating a process of acquiring and removing data over a total time period by a dataset configuration device S according to an embodiment of the present disclosure.

In FIG. 2, Du may refer to an unlabeled data pool where an unlabeled dataset is stored. D_{L} may refer to a labeled data pool where labeled dataset are stored.

In the disclosed embodiment, useful data may be identified from the unlabeled data pool Du and accumulated in the labeled data pool D_{L} (solid arrow) through active learning, and unuseful data (i.e., data to be removed) may be identified from an updated labeled data pool D_{L} and moved to the unlabeled data pool Du (dashed arrow) through active forgetting.

Here, the purpose of executing the active forgetting is to eliminate less useful data in order to find useful data for learning while optimizing data budget allocation.

In active learning, the classifier 200 may identify useful data from the unlabeled data pool Du at the current point in time using a currently trained deep learning model M_{θ}. The classifier 200 may evaluate unlabeled data using the knowledge of the currently trained deep learning model M_{θ}. Based on this evaluation, data with high information content may be identified as useful data.

In active forgetting, the classifier 200 may identify unuseful data from the labeled data pool D_{L} at the current time point using the currently trained deep learning model M_{θ}. The classifier 200 may calculate a non-usefulness score for each data to select data that is not useful for performing the task.

Specifically, the non-usefulness score of the i-th instance (x⁽ⁱ⁾, y^{(i,t)}) (x is data, y is a label) for task t may be calculated by the difference between the loss when a deep learning model is trained using the data and the loss when unlearning is performed on the deep learning model using the data, as shown in Equation 1 below.

$${\sum }_{n \neq i , k \neq t} ℒ ( {ℳ}_{θ} ( {x}^{( n )} ) , {y}^{( n , k )} ) - ℒ ( {ℳ}_{θ}^{′} ( {x}^{( n )} ) , {y}^{( n , k )} ) , \qquad Equation 1$$

Here, [symbol] represents loss, M_{θ} represents the model trained using the current labeled dataset, and M′_{θ} represents a model subjected to unlearning on the corresponding data. That is, M′_{θ} represents the model trained after removing the data. The larger the loss difference (gap) between the two models, the more the model performance improves when the corresponding data is removed. Therefore, removing samples with high scores that can affect model performance is beneficial to the model.

In this way, when performing learning through a selective labeling system S using active learning and active forgetting according to an embodiment of the present disclosure, unimportant data that is not useful is removed, and the dataset is composed of only useful data, and thus the performance of the model may be further improved at a low labeling cost.

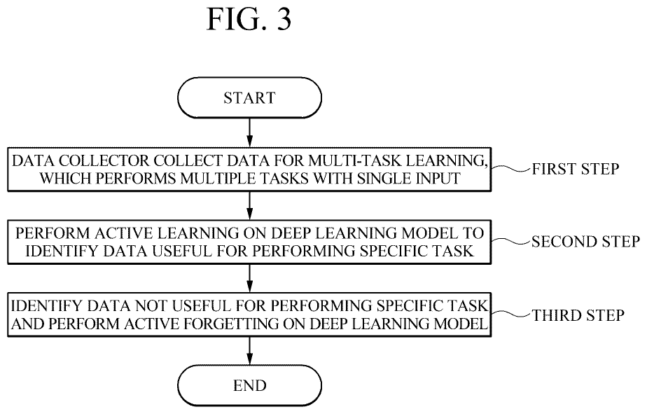

FIG. 3 is a flowchart illustrating a method of constructing a dataset for multiple tasks through selective labeling according to an embodiment of the present disclosure.

First, the data collector 100 collects data for multi-task learning, which performs multiple tasks with a single input (First step).

Next, the classifier 200 performs active learning on a deep learning model to identify data useful for performing a specific task (Second step).

Next, the classifier 200 identifies data not useful for performing the specific task and performs active forgetting on the deep learning model (Third step).

The model may be trained by obtaining useful data classified by the classifier 200, and the process of removing the unuseful data and performing unlearning may be repeated.

According to the disclosed embodiment, an optimal set D_{L} of labeled samples can be constructed. Hereinafter, the configuration of the optimal set D_{L} will be described.

For multi-task learning, data is interpreted in units of tasks and labeled data may be expressed by Equation 2 below.

$${D}_{L}^{( t )} = \{ X , {Y}^{( t )} \} \qquad Equation 2$$

In the Equation 2, X represents input data, Y^{(t)} and is the label of the task t corresponding to the input data. The total number of tasks is T, and the value of t may range from 1 to T.

Labeled data may be expressed as Equation 3 below through active learning and active forgetting.

$${D}_{L}^{( t )} = 𝒜 ( {ℳ}_{θ} , {D}_{U}^{( t )} ) - ℛ ( {ℳ}_{θ} , {D}_{L}^{( t )} ) \qquad Equation 3$$

In the above Equation 3,

$${D}_{L}^{( t )}$$

represents the labeled dataset of task t, and data is added to this dataset through active learning of [symbol] (⋅), and data is removed from this dataset through active forgetting of [symbol] (⋅).

In active learning, useful data is identified and obtained from the unlabeled data

$${D}_{U}^{( t )}$$

using the currently trained model [symbol] _{θ}. In active forgetting, unuseful data is identified and removed from the labeled data

$${D}_{L}^{( t )}$$

using the currently trained model [symbol] _{θ}.

In the active forgetting, model unlearning is performed to remove data, and the knowledge of the model refined through unlearning is utilized to identify useful data in active learning.

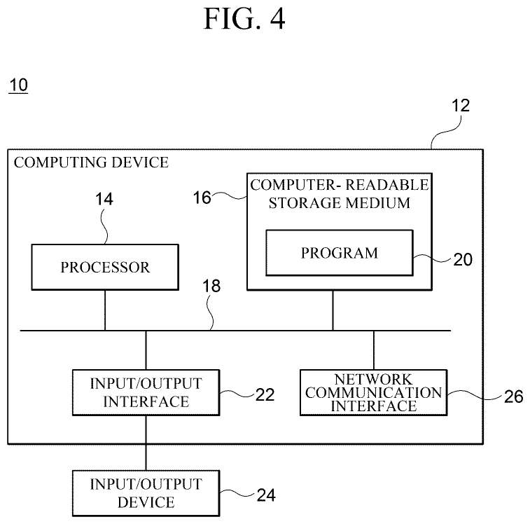

FIG. 4 is a block diagram illustrating a computing environment 10 including a computing device suitable for use in embodiments of the present disclosure. In the illustrated embodiment, respective components may have different functions and capabilities other than those described below, and include additional components in addition to those described below.

The illustrated computing environment 10 includes a computing device 12. In an embodiment, the computing device 12 may be a learning device S for multiple tasks that performs selective labeling using active learning and active forgetting.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, unuseful data is removed and a dataset is composed of only useful data by performing learning through a selective labeling method utilizing active learning and active forgetting, thereby capable of improving model learning performance with lower labeling costs and providing stable multi-task learning performance.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A device that includes a processor and a memory storing one or more programs executed by the processor, comprising:
a data collector configured to collect data for multi-task learning; and
a classifier comprising a deep learning model configured to perform the multi-task and classify useful data useful for performing a specific task through active learning using the deep learning model among the collected data, and unuseful data not useful for performing the specific task through active forgetting using the deep learning model among the identified useful data.

2. The device of claim 1, wherein the data collector is configured to divide the collected data into a labeled dataset and an unlabeled dataset and store the labeled dataset in a labeled data pool and the unlabeled dataset in an unlabeled data pool.

3. The device of claim 2, wherein the classifier is configured to:
identify useful data from the unlabeled data pool through the active learning and add useful data to the labeled data pool; and
identify unuseful data from the labeled data pool through the active forgetting and move the unuseful data to the unlabeled data pool.

4. The device of claim 1, wherein the classifier is configured to calculate a non-usefulness score for each data to select data that is not useful for performing the task.

5. The device of claim 4, wherein the non-usefulness score is calculated for each data by a difference between a loss when the deep learning model is trained using the data and a loss when the deep learning model is subjected to unlearning on the data.

6. A method performed on a computing device comprising one or more processors and a memory storing one or more programs executed by the one or more processors, the method comprising:
collecting data for multi-task learning; and
classifying useful data useful for performing a specific task through active learning using the deep learning model among the collected data, and unuseful data not useful for performing the specific task through active forgetting using the deep learning model among the identified useful data.

7. The method of claim 6, wherein the collecting of the data includes:
dividing the collected data into a labeled dataset and an unlabeled dataset; and
storing the labeled dataset in a labeled data pool and the unlabeled dataset in an unlabeled data pool.

8. The method of claim 7, wherein, in the classifying, useful data is identified from the unlabeled data pool through the active learning and adding useful data to the labeled data pool, and unuseful data is identified from the labeled data pool through the active forgetting and moving the unuseful data to the unlabeled data pool.

9. The method of claim 6, wherein the classifying includes calculating a non-usefulness score for each data to select data that is not useful for performing the task.

10. The method of claim 9, wherein the non-usefulness score is calculated for each data by a difference between a loss when the deep learning model is trained using the data and a loss when the deep learning model is subjected to unlearning on the data.

11. A computer program stored on a non-transitory computer readable storage medium, the computer program including one or more instructions, the instructions, when executed by a computing device having one or more processors, causing the computing device to perform:
collecting data for multi-task learning; and
classifying useful data useful for performing a specific task through active learning using the deep learning model among the collected data, and unuseful data not useful for performing the specific task through active forgetting using the deep learning model among the identified useful data.
